(19) United States
(12) Patent Application Publication
(10) Pub. No.: US 2013/0219785 A1
(43) Pub. Date: Aug. 29, 2013

(54) APPARATUSES, KITS, SYSTEMS, AND METHODS FOR PROTECTING AND/OR SUPPORTING A PLANT DURING A GROWTH CYCLE OF THE PLANT

(71) Applicant: Michael H. Ritchotte, Raleigh, NC (US)

(72) Inventor: Michael H. Ritchotte, Raleigh, NC (US)

(21) Appl. No.: 13/765,282

(22) Filed: Feb. 12, 2013

Related U.S. Application Data
(60) Provisional application No. 61/599,171, filed on Feb. 15, 2012.

(51) Int. Cl. A01G 9/12

(52) U.S. Cl. CPC A01G 9/12
USPC 47/45; 47/44; 47/58.1 R

(57) ABSTRACT

Plant support systems and methods for supporting and protecting plants are provided. Plant support systems can include a support frame made from a mesh material. A support frame can include apertures which allow the plant to grow through the support frame thereby providing support to substantially all of the plant while also concealing the support system. A plant support system can include stakes or anchors for securing the support system to a planting surface. A plant support system can be suitable for various sizes and types of plants, and can have an adjustable diameter to fit such varying sizes and types. A plant support system as disclosed herein can be suitable for supporting and protecting a plant throughout the lifecycle of a plant.

### CROSS-REFERENCE TO RELATED APPLICATIONS

This application is a non-provisional of and claims priority to U.S. Provisional Application Ser. No. 61/599,171, filed Feb. 15, 2012, the entire content of which is hereby incorporated by reference.

### TECHNICAL FIELD

The present disclosure relates generally to horticultural and/or plant support systems for use to protect and/or support one or more plants during at least a portion of a life cycle and/or growth cycle of the respective plants. More specifically, the presently disclosed subject matter is directed to apparatuses, kits, systems, and methods for protecting and/or supporting a plant during a growth cycle of the plant.

### BACKGROUND

Avid gardeners, vegetable growers, horticulturalists and plant nursery operators have sought improved ways to maintain and support the structural and ornamental qualities of their flowers and plant. If adequate support is provided to a plant it is less likely to suffer damage caused by the elements (wind and rain) and/or the plant's own weight, i.e. damage is caused by the stalk snapping or splitting. If a plant is damaged due to lack of adequate support the damage invites predation by insects and increases susceptibility to disease. In other cases, the damage is too severe, causing death of the plant. In less severe cases, the sagging plant is less aesthetically pleasing and/or less productive.

Existing support products suffer from significant drawbacks, such as unsuitability for plants of various heights, providing support to only a portion of the plant instead of the entire plant, and non-adjustability to accommodate varying sizes of plants. Moreover, existing plant support products are not suitable for supporting a plant throughout its growth cycle, i.e. from first planting to full maturity. Further, many existing supports remain highly visible and not aesthetically pleasing even as the plant matures.

Accordingly, there is a need to support flowers less than 2 feet high, to support the majority of the flower from the ground up, and to offer an adjustable support diameter that will support a wider variety of flower spread size, and for the gardener to be able to choose when best to apply support, from first planting to later stages in the flower growth cycle. It is also important to provide thorough support and be aesthetically pleasing.

As such, a need exists for plant support apparatuses, kits, systems and methods for protecting and/or supporting plants of various sizes during at least a portion of a life cycle and/or growth cycle of the respective plants and in some instances throughout the entire growth cycle of the plant.

### SUMMARY

It is an object of the presently disclosed subject matter to provide novel apparatuses, kits, systems and methods for protecting and/or supporting a plant during a growth cycle of a plant.

An object of the presently disclosed subject matter having been stated hereinabove, and which is achieved in whole or in part by the presently disclosed subject matter, this and other objects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a side view of a plant support system;

FIG. 2 is a plan view of a first embodiment of a plant support system, including components that can be provided in a plant support system kit;

FIG. 3 is a close-up view of a section of an embodiment of a mesh material of a plant support system;

FIG. 4 is a perspective view of an embodiment of a mesh wall structure of a support frame of a plant support system in an upright and partially deformed position;

FIG. 5 is a side view of an embodiment of a mesh wall structure of a support frame of a plant support system in an upright and partially deformed position;

FIG. 6 is a top view of an embodiment of a mesh wall structure of a support frame of a plant support system in an upright and partially deformed position;

FIG. 7 is a perspective view of an embodiment of a support frame of a plant support system in an upright and fully deformed position to form a support frame;

FIG. 8 is a side view of an embodiment of a support frame and anchors of a plant support system;

FIG. 9 is a plan view of a second embodiment of a plant support system, including components that can be provided in a plant support system kit;

FIG. 10 is a perspective view of a second embodiment of a support frame of a plant support system in an upright and fully deformed position to form a support frame;

FIG. 11 is a plan view of a third embodiment of a plant support system, including components that can be provided in a plant support system kit;

FIG. 12 is a perspective view of a third embodiment of a support frame of a plant support system used in conjunction with a stake;

FIG. 13 is a side view of a plant support system in use to provide structural support to a plant through various stages of growth of the plant;

FIGS. 14A-14C are plan views of a mesh material in a series of steps illustrating the creation of apertures in the mesh material to thereafter be used to create a mesh wall structure of a support frame of a plant support system; and

FIGS. 15A-15D are side views of a plant support system in use to provide structural support to a plant through various stages of growth of the plant.

### DETAILED DESCRIPTION

The present disclosure relates generally to horticultural and/or plant support systems for use to protect and/or support one or more plants during at least a portion of a life cycle and/or growth cycle of the respective plants. More specifically, the presently disclosed subject matter is directed to apparatuses, kits, systems, and methods for protecting and/or supporting a plant during a growth cycle of the plant.

While the following terms are believed to be well understood by one of ordinary skill in the art, the following definitions are set forth to facilitate explanation of the presently disclosed subject matter.

Following long-standing patent law convention, the terms “a” and “an” mean “one or more” when used in this application, including the claims.

Unless otherwise indicated, all numbers expressing units of measure, e.g. distance or weight, used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or unit of measure is meant to encompass variations of in some embodiments ±20%, in some embodiments ±10%, in some embodiments ±5%, in some embodiments ±1%, in some embodiments ±0.5%, and in some embodiments ±0.1% from the specified value, as such variations are appropriate to make and/or use the disclosed devices and perform the disclosed methods.

As used herein, the term “and/or” when used in the context of a listing of entities, refers to the entities being present singly or in combination. Thus, for example, the phrase

“A, B, C, and/or D” includes A, B, C, and D individually, but also includes any and all combinations and subcombinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole. As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

In some embodiments, a plant support system is provided that comprises a mesh material that has openings, or apertures, therein and that can be deformable into a cylindrical support frame. For example, the wall structure can be, in some embodiments, a mesh wall structure. The support frame can be securably positioned around a perimeter of at least a portion of a plant at a first stage of growth of the plant. The support frame can be used to protect fledging plants from weather and animals. As the plant grows and expands, the plant can grow through the mesh wall structure, and particularly the apertures, so that the support frame can provide support to the plant to facilitate a proper posture of the plant. In particular, the mesh wall structure can define apertures therein that are a plurality of shapes and sizes that permits growth of the plant therethrough so that the support frame is at least partially concealable by the plant at a later stage of growth and provides infrastructural support to the plant.

In another example, an embodiment of a plant support system comprises a mesh wall structure that defines apertures of a plurality of different shapes and sizes therein. The mesh wall structure can be deformable into a support frame that can be positioned at a perimeter of at least a portion of a plant. The apertures of different shapes and sizes can be positioned at different locations in the support frame to facilitate growth therethrough by the plant. At least one securement mechanism can be provided for securing the support frame to a ground surface at the perimeter of the plant.

In some embodiments, one or more fasteners, such as for example clips or twist ties, can be provided that can be secured to the mesh wall structure to hold the mesh wall structure in a deformed shape of the support frame. For example, the one or more fasteners can comprise one or more clips, twist ties, or the like. For instance, the one or more clips can comprise discrete clips that are securable on overlapping portions of the mesh wall structure. Additionally or alternatively, the one or more clips can comprise at least one clip portion integral to the mesh wall structure under which an overlapping portion of the mesh wall structure can be secured. In some embodiments, the one or more fasteners can comprise one or more snaps on opposing portions of the mesh wall structure when deformed into the support frame. The snaps can engage one another to hold the mesh wall structure in the shape of the support frame. Further, the one or more fasteners can comprise one or more ties that are securable on overlapping portions of the mesh wall structure.

In some embodiments, the mesh wall structure can comprise a repeating pattern of apertures. The mesh wall structure can be made from different types of material. The mesh wall structure can comprise a plastic, for example. For example, in some embodiments, the mesh wall structure can comprise a molded plastic. Alternatively, the mesh wall structure can comprise a pressed plastic. Still yet, in some embodiments the mesh wall structure can comprise a wire mesh that in some embodiments can be coated with plastic.

In some embodiments, the mesh wall structure can comprise a skeletal framework of interconnected links that define the apertures of the plurality of different shapes and sizes in the mesh wall structure. The apertures can comprise different geometric shapes, such as shapes that are polygonal or curved in nature, or combinations thereof. For example, the apertures of the plurality of different shapes and sizes defined by the mesh wall structure can comprise at least one of hexagonal shape, rectangular shape, circular shape, oval shape, elliptical shape, triangular shape, star shape, slot shape, hexagonal slot shape, hexagonal star shape, hexslot, hexstar, or curved slot or curved star shapes, which comprise overlapping circles, for instance. The apertures can comprise other geometrical and non-geometrical shapes. Other non-limiting examples of shapes include trapezoidal, parallelogramal, stacked multi-rectangular, diamond, and stacked diamond shapes.

In some embodiments, the support frame formed by the mesh structure can comprise a ring. For example, the support frame can comprise a cylindrical ring. In such embodiments, the support frame can be adjustable to different diameters. For example, the mesh wall structure can be attached at different locations to change or adjust the diameter of a ring-shaped support frame. The apertures in the mesh wall structure can be alignable when the mesh wall structure is deformed into the support frame such that the apertures in the mesh wall structure are generally not blocked by solid portions of the mesh wall structure. For example, the mesh wall structure can have tabs thereon that can be aligned when the mesh wall structure is deformed into the support frame to ensure that the apertures are properly aligned. The tabs can be positioned along an edge, such as a top or upper edge, or bottom or lower edge, of the mesh wall structure and can have a size and shape that provides a secure engagement with the clips or other fasteners so that the clips or other fasteners hold the mesh wall structure in place. In some embodiments, the tabs can comprise indicators thereon to identify a size of the support frame being formed when the tabs are aligned. The indicators on the tabs can have markings thereon so that respective tabs can be matched to form different settings to which a diameter of the support frame is adjustable.

In some embodiments, one or more securement structures or mechanisms to secure the support frame to the ground surface can comprise one or more ground anchors. In some embodiments, one or more hooked ground anchors can be configured to engage the mesh wall structure at one of the apertures. Alternatively, in some embodiments, the at least one securement mechanism can comprise one or more spikes integral with and extending from a bottom side of the mesh wall structure. In some embodiments, the securement mechanisms, including for example the ground anchors, can be made from aluminum, plastic, metal, plastic-coated metal, a synthetic composite material, or combinations thereof. In some embodiments, the securement mechanisms can be made of a non-corrosive material such as aluminum or plastic.

The plant support systems disclosed herein can be packaged in a kit, which, in some embodiments, can provide the ability to support multiple plants. In some embodiments, a kit can comprise sufficient components to assemble a plurality of plant support systems, either of the same size or of multiple sizes. In some embodiments, kits can comprise components sufficient to construct plant support systems of a desired size for a desired application.

For example, a plastic mesh flower support ring kit can comprise at least two plastic mesh support frames with one or more support frames having a different height to support a wide variety of plant, in particular flower, types for supporting plants up to about 24 inches high. Each support ring can comprise multiple diameter size-adjustment settings. The kits can also comprise open hooked ground anchors for establishing grounded foundation support for the support frames. The plastic mesh support ring kit can further comprise at least one of clips or plastic coated, metal twist ties for securing a selectable diameter size of at least one of the support frames. The clips can for example be FLOWERCORSET™ Secure Clips to be sold by FlowerCorset, Inc. (Raleigh, N.C., United States of America). As above, each support structure can comprise a mesh pattern. For example, the pattern can comprise a mesh size comprising about ¾ inch hexagonal apertures, and a FlowerCorset “Grow Through Design”™ with HEXSTAR™ and/or HEXSLOT™ meshes also to be sold by FlowerCorset, Inc. In some embodiments, one of the support frames provides up to 5 selectable diameter support sizes (FCGS-5 to be sold by FlowerCorset, Inc.), and another support frame comprises up to 6 selectable diameter support sizes (FCGS-7 to be sold by FlowerCorset, Inc.).

Plant support systems and methods disclosed herein can be used to structurally support and enhance the growth and health of any type or variety of plant in need thereof. By way of example and not limitation, plants suitable for use with the disclosed plant support systems and methods can include flowering plants, fruit or vegetable bearing plants, decorative plants, edible plants, landscaping plants, shrubs, etc. Plant support systems and methods disclosed herein can be used by gardeners, landscapers, horticulturalists, etc.

Reference will now be made in detail to possible aspects or embodiments of the subject matter herein, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations. As illustrated in the various figures, some sizes of structures or portions may be exaggerated relative to other structures or portions for illustrative purposes and, thus, are provided to illustrate the general structures of the present subject matter.

Although the terms first, second, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure herein.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures may be schematic in nature and their shapes and/or positions are not intended to illustrate the precise configuration of a system or apparatus and are not intended to limit the scope of the subject matter disclosed herein.

Embodiments of the present disclosure shown in the drawings and described above and below are exemplary of numerous embodiments that can be made within the scope of the subject matter disclosed herein. It is contemplated that the configurations of horticultural and/or plant support systems and kits, apparatuses, devices, and methods for providing protection and/or support one or more plants during at least a portion of a life cycle and/or growth cycle of the respective plants can comprise numerous configurations other than those specifically disclosed herein.

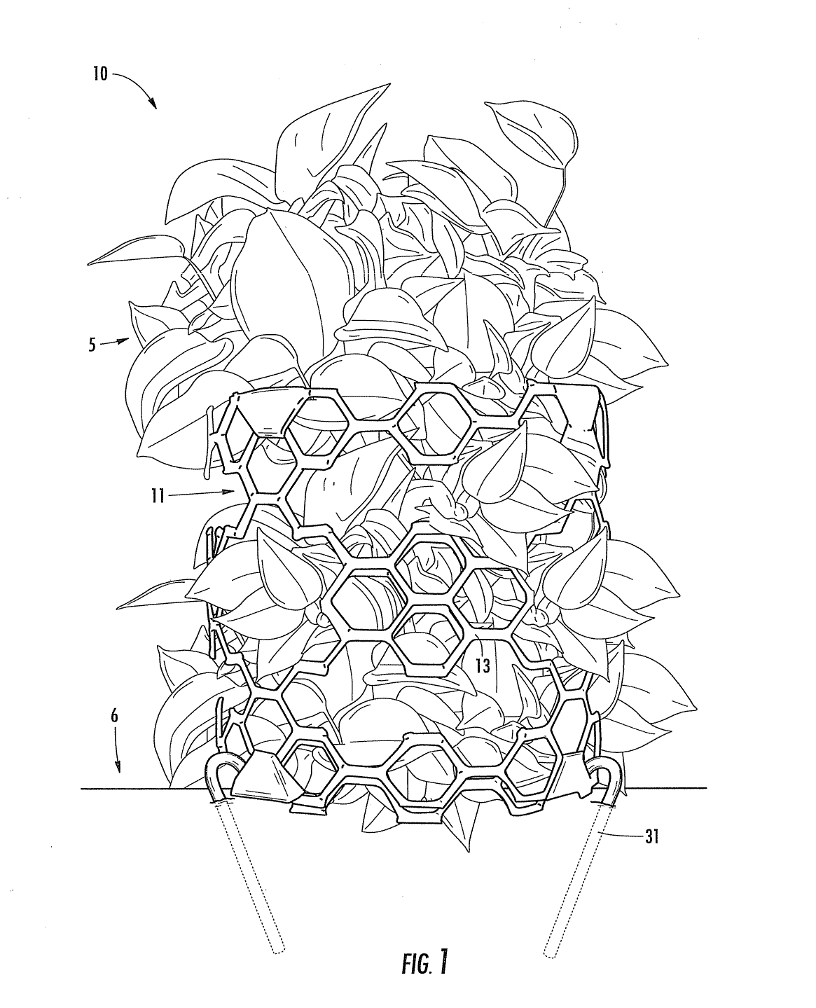

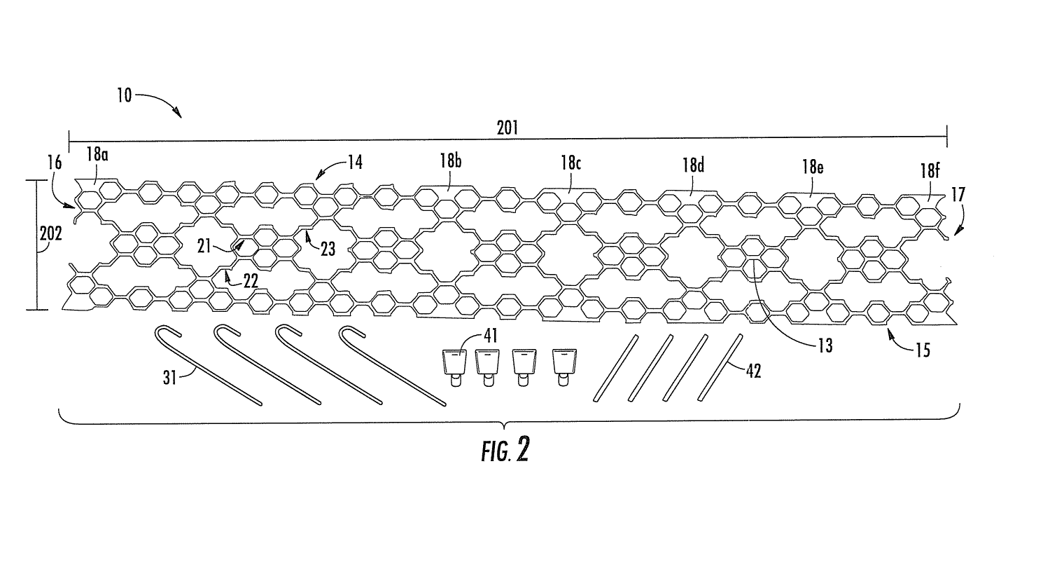

FIG. 1 is a side view of a plant support system supporting a plant. Plant 5 is supported in an upright position by plant support system 10. Support frame 11 of plant support system 10 extends vertically from the surface of the ground surface 6 with support frame 11 providing a cylindrical support structure around the periphery of plant 5. As is visible in FIG. 1, portions of plant 5, e.g. leaves and stems, extend above the top and open end of support frame 11 of plant support system 10. Additionally, as discussed further hereinbelow, portions of plant 5, e.g. leaves and stems, also extend or pass through apertures of holes in the sides of support frame 11 of plant support system 10. Finally, FIG. 1 also illustrates securement mechanisms, and particularly anchors 31, which secure support frame 11 to ground surface 6. FIG. 2 is a plan view of a first embodiment of a plant support system 10, including components that can be provided in a plant support system kit. Plant support system 10, as illustrated in FIG. 2, can comprise a mesh material 13 (used to form a mesh wall structure of a support frame as discussed below), a securement mechanism, such as for example anchors 31, and fasteners, including for example clips 41 and/or twist ties 42. Mesh material 13 can comprise a substantially planar structure of various widths and lengths and having holes, perforations or apertures throughout. Mesh material 13 can comprise an upper edge 14, a lower edge 15, a first end 16 and a second end 17. Mesh material 13 can comprise tabs 18 distributed along upper edge 14 and/or lower edge 15 as desired. Apertures 21, 22 and 23 in mesh material 13 can comprise various shapes and sizes depending on the desired application of plant support system 10.

Mesh material 13 can have any desirable length 201, or can be cut to any desirable length. In some embodiments, mesh material 13 as depicted in FIG. 2 can have a length 201 ranging from about 15 inches to about 40 inches. In some embodiments, mesh material 13 as depicted in FIG. 2 can have a length 201 of about 15, 16, 17, 18, 19, 20, 21, 22, 23, 24, 25, 26, 27, 28, 29, 30, 31, 32, 33, 34, 35, 36, 37, 38, 39 or 40 inches. In some embodiments, mesh material 13 as depicted in FIG. 2 can have a length 201 of about 29 inches. In some embodiments, mesh material 13 as depicted in FIG. 2 can have a height 202 of about 3 inches to about 9 inches. In some embodiments, mesh material 13 as depicted in FIG. 2 can have a height 202 of about 3, 4, 5, 6, 7, 8 or 9 inches. In some embodiments, mesh material 13 as depicted in FIG. 2 can have a height 202 of about 5 inches.

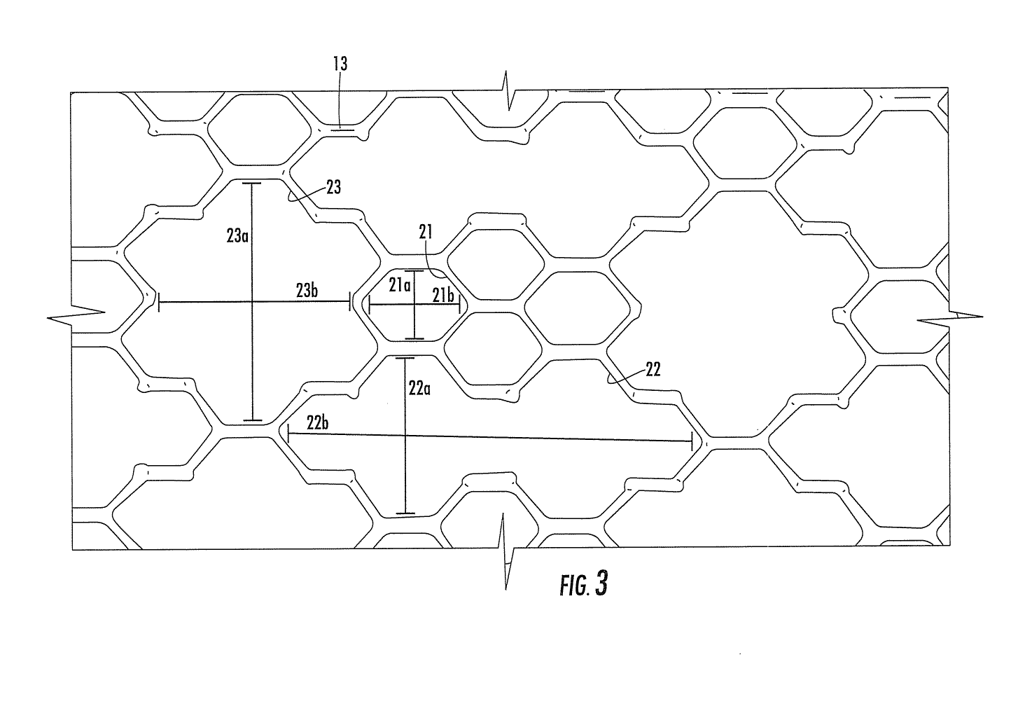

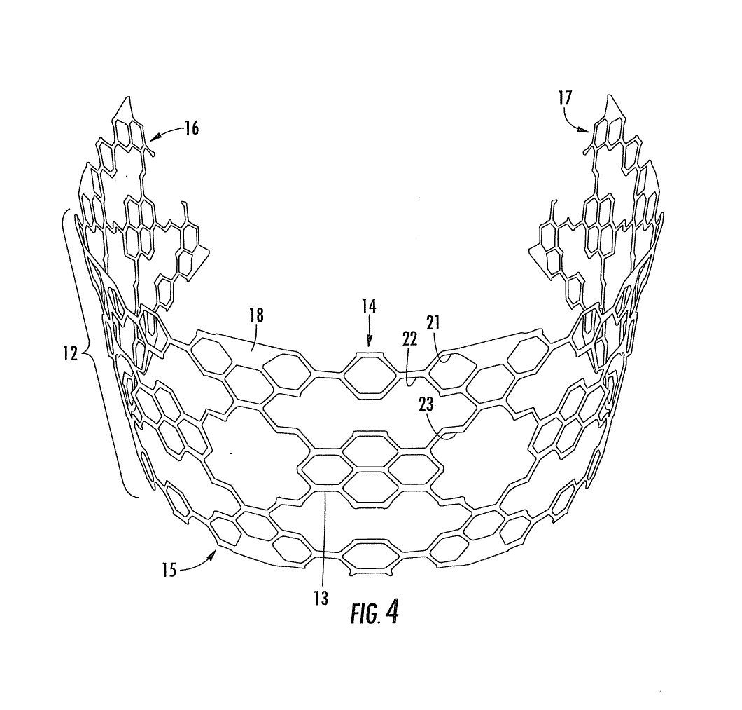

In some embodiments, mesh material 13 as depicted in FIG. 2 can have tab 18a on upper edge 14 and/or lower edge 15 and proximal to first end 16. In some embodiments, mesh material 13 can have an additional one to nine tabs 18 spaced along upper edge 14 and/or lower edge 15 and starting from second end 17. By way of example and not limitation, FIG. 2 depicts tabs 18b, 18c, 18d, 18e and 18f. Alignment of tabs 18b, 18c, 18d, 18e and 18f with 18a, when mesh material 13 is deformed into support frame 11 (see FIGS. 4-7), provide for a support frame 11 with a diameter of 4 inches, 5.5 inches, 7 inches, 8.5 inches and 10 inches, respectively. That is, tabs 18b (4 inch tab), 18c (5.5 inch tab), 18d (7 inch tab), 18e (8.5 inch tab), and 18f (10 inch tab), when aligned with tab 18a, provide a guide for a desired diameter of support frame 11. FIG. 3 is a close-up view of a section of an embodiment of mesh material 13 of plant support system 10. In some embodiments, mesh material 13 can comprise a repeating pattern of apertures. Mesh material 13 can be made from different types of material. Mesh material 13 can comprise a plastic, for example. For example, in some embodiments, mesh material 13 can comprise a molded plastic. Alternatively, mesh material 13 can comprise a pressed plastic. Still yet, in some embodiments Mesh material 13 can comprise a wire mesh that in some embodiments can be coated with plastic.

In some embodiments, mesh material 13 can comprise a skeletal framework of interconnected links that define the apertures of the plurality of different shapes and sizes in mesh material 13. The apertures can comprise different geometric shapes, such as shapes that are polygonal or curved in nature, or combinations thereof. For example, the apertures of the plurality of different shapes and sizes defined by mesh material 13 can comprise at least one of hexagonal shape, rectangular shape, circular shape, oval shape, elliptical shape, triangular shape, star shape, slot shape, hexagonal slot shape, hexagonal star shape, hexslot, hexstar, or curved slot or curved star shapes, which comprise overlapping circles, for instance. The apertures can comprise other geometrical and non-geometrical shapes. Other non-limiting examples of shapes include trapezoidal, parallelogramal, stacked multi-rectangular, diamond, and stacked diamond shapes.

FIG. 3 illustrates hexagonal shaped apertures 21, as well as hexslot 22 and hexstar 23 apertures. Hexagonal shaped apertures 21, hexslot apertures 22 and hexstar apertures 23 apertures can be present simultaneously on a mesh material 13, and in some embodiments can be present in a repeating pattern as depicted in FIGS. 2 and 3. Hexagonal shaped apertures 21 can comprise hexagonal shapes of various sizes, including for example a hexagon about % inches high and % inches wide. In some embodiments, hexagonal shaped aperture 21 can have a height 21a of about ¼, ½, 1, 1½, 2, 2½, 3, 4 or 5 inches and a width 21b of about ¼, ½, ¾, 1, 1½, 2, 2½, 3, 4 or 5 inches. In some embodiments, hexslot aperture 22 can have a height 22a at its highest point of about ¼, ½, ¾, 1, 1½, 2, 2½, 3, 4, or 5 inches and a width 22b at it widest point of about ¼, ½, ¾, 1, 1½, 2, 2½, 3, 4 or 5 inches. In some embodiments, hexstar aperture 23 can have a height at its highest point 23a of about ¼, ½, ¾, 1, 1½, 2, 2½, 3, 4 or 5 inches and a width 23b at its widest point of about ¼, ½, ¾, 1, 1½, 2, 2½, 3, 4 or 5 inches.

Hexslot 22 apertures can in some embodiments be designed to allow growth of wide leaf sizes of a plant, or clustered portions of a plant, through the aperture. Such a design provides for shapely mounding of the plant, supported growth and renders the plant support system 10 virtually invisible. Hexstar 23 apertures can in some embodiments be designed to allow growth of thicker portions of a plant, or clustered portions of a plant, through the aperture. Such a design provides for shapely mounding of the plant, supported growth and renders the plant support system 10 virtually invisible.

FIG. 4 is a perspective view of an embodiment of mesh material 13 partially deformed and in the initial formation stages of a support frame 11 (see FIG. 7) of a plant support system 10. The mesh wall structure 12 made of mesh material 13 is in an upright and partially deformed position in FIG. 4. Mesh material 13 can begin to be formed into a support frame 11 (see FIG. 7) by bending the first end 16 and second end 17 of mesh material 13 toward one another.

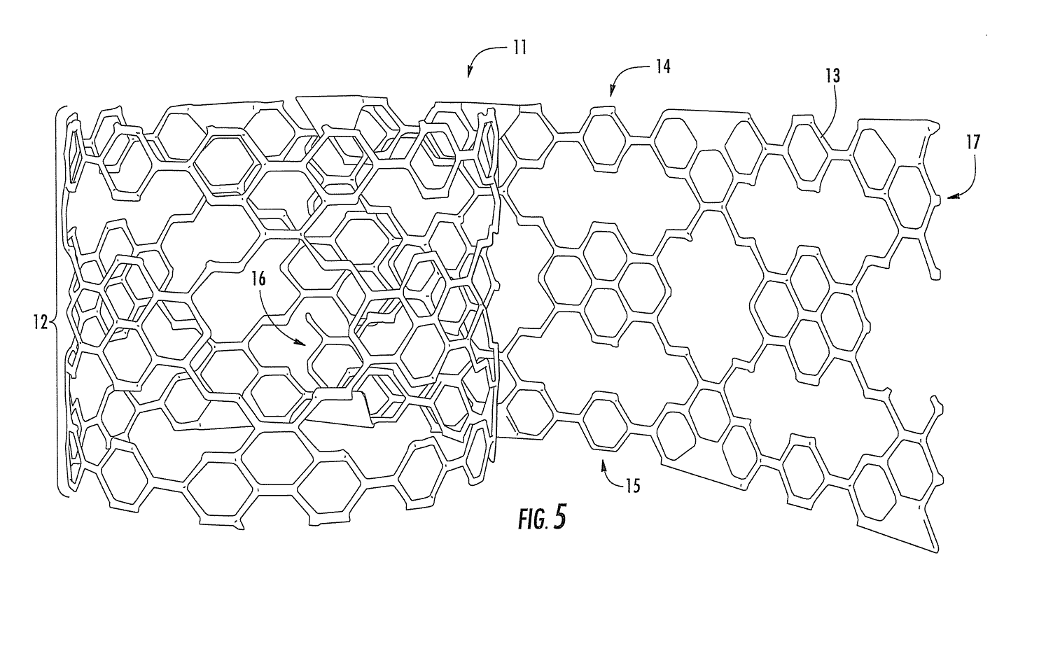

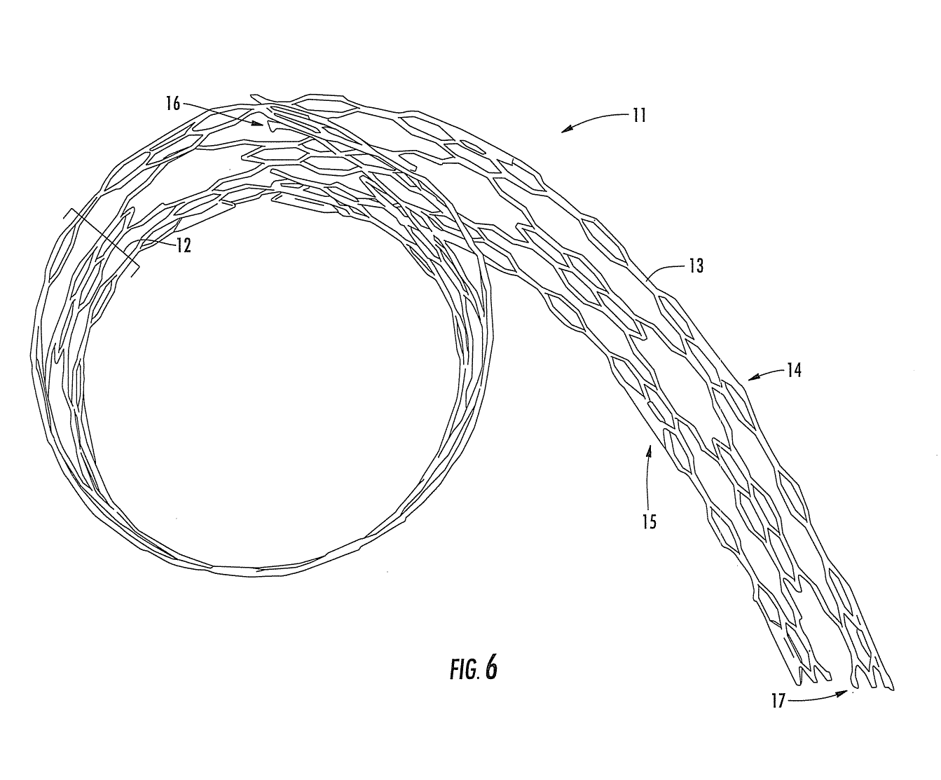

FIGS. 5 and 6 are side and top views, respectively, of a support frame 11 being formed from a mesh material 13. The deformation of mesh material 13 as depicted in FIG. 4 is continued further, as depicted in FIGS. 5 and 6, by folding first end 16 further towards mesh material 13 to form the beginnings of a cylinder, wherein the cylinder structure forms support frame 11 comprising mesh wall structure 12.

Support frame 11, comprising a cylindrical structure formed from mesh material 13 and having a mesh wall structure 12, is completed as depicted in FIG. 7. The support frame 11 of plant support system 10 is depicted in FIG. 7 is in an upright position. To hold mesh material 13 in the cylindrical shape to provide for the support frame 11 fasteners 41 can be used to secure first and second ends 16 and 17 into place. In some embodiments, fasteners 41 can comprise a clip that can slide over the top of upper edge 14 and/or lower edge 15 of mesh material 13 to hold first and second ends 16 and 17 into place. In some embodiments, fasteners 41 can be secured on both upper edge 14 and lower edge 15 of mesh material 13 to hold first and second ends 16 and 17 into place. As depicted in FIG. 7, in some embodiments four fasteners 41 can be used simultaneously to retain the cylindrical shape of support frame 11. However, as would be appreciated by one of ordinary skill in the art, any number of fasteners 41 can be used as necessary to retain the cylindrical shape of support frame 11.

In an upright position as depicted in FIG. 7 support frame 11 can comprise an upper edge 14 and lower edge 15. In some embodiments, and as depicted in FIG. 7, mesh material 13 deformed into the cylindrical structure support frame 11 forms overlapping regions 51 of mesh material 13. The degree to which overlapping regions 51 exist is determined by the diameter of the cylindrical structure of support frame 11. That is, for a given length of mesh material 13, deformation of mesh material 13 into a smaller diameter cylinder will result in more overlap regions 51 as compared to deformation of the same length of mesh material 13 into a larger diameter cylindrical. A user of a support frame 11 and plant support system 10 disclosed herein can choose the appropriate diameter for support frame 11, depending in part on the particular application of the plant support system 10. Moreover, the diameter of support frame 11 can be adjusted as needed by removing fastener(s) 41 and adjusting the deformation of mesh material 13 to achieve the desired diameter.

Support frame 11 can, in some embodiments, have a height of about 3, 4, 5, 6, 7, 8 or 9 inches. As depicted in FIG. 7, support frame 11 can have a height of about 5 inches. Support frame 11 can, in some embodiments, have a diameter of about 4, 5.5, 7, 8.5 or 10 inches. Support frame 11 as depicted in FIG. 7 can be suitable for supporting plants expected to grow to about 7 to about 14 inches in height.

As depicted in FIG. 7, wall structure 12 of support frame 11 can comprise hexagonal shaped apertures 21, hexslot apertures 22 and hexstar apertures 23 apertures. As one of ordinary skill in the art will appreciate, any size, shape and/or combination of aperture(s) can be used in mesh wall structure 12 of support frame 11 without departing from the scope of the instant disclosure. Some considerations for the size and shape of the aperture(s) employed in a given mesh wall structure 12 of support frame 11 can include the type of plant to be supported by support frame 11, the stage of growth of the plant, the stage of the growing season, the environment and/or soil condition where the plant is to be grown, the presence or absence of pests, etc.

In some embodiments, and as depicted in FIG. 7, these apertures (21, 22 and 23) can be aligned in overlapping regions 51 of mesh material 13 so as not to obstruct the openings of each of apertures 21, 22 and 23. To facilitate the alignment of the apertures 21, 22 and 23, tabs 18 can be provided in some embodiments. Tabs 18 can be placed at or near the top (upper edge 14) of support frame 11 and/or at or near the bottom (lower edge 15) of support frame 11. Tabs 18 can be arranged such that alignment thereof ensures that apertures (such as apertures 21, 22 and 23) in wall structure 12 are also aligned. In some embodiments, a plurality of tabs 18 can be provided along upper edge 14 and/or lower edge 15, as depicted in FIG. 7. In some embodiments, tabs 18 can have a size and shape that provides a secure engagement with the fastener(s) 41 so that fastener(s) 41 securely hold mesh material 13 in place to form support frame 11. In some embodiments, tabs 18 can comprise indicators thereon to identify a size of the support frame 11 being formed when tabs 18 are aligned. The indicators on tabs 18 can have markings thereon so that respective tabs 18 can be matched to form different settings to which a diameter of support frame 11 is adjustable.

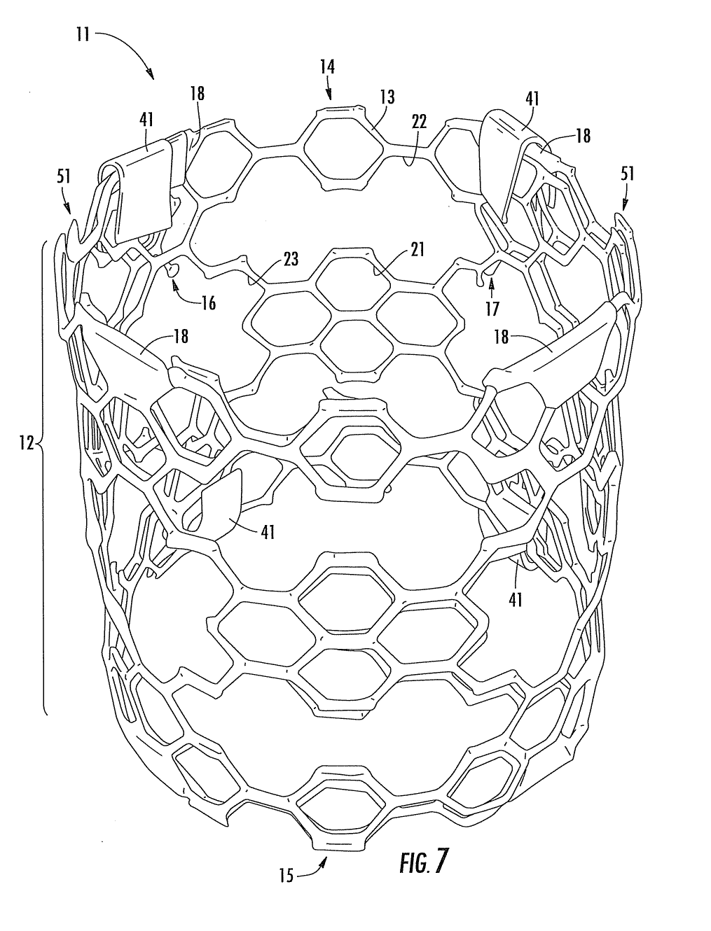

FIG. 8 is a side view of an embodiment of plant support system 10 disclosed herein, including support frame 11 and anchors 31. Anchor 31 can act as a securement structure or device to secure support frame 11 to a surface 6. In some embodiments, surface 6 can comprise the surface of the ground, or the surface of a soil or planning medium in a pot, tray, planter, growing bed or other growing container. Anchor 31 can comprise a rod, stake, spike or stick with a curved or hooked end, wherein the curved or hooked end is configured to engage the lower end 15 of wall structure 12 of support frame 11. Anchor 31 can comprise one or more spikes integral with and extending from lower end 15 of wall structure 12. Anchor 31 can, in some embodiments, be about 2, 2.5, 3, 3.5, 4, 4.5, 5, 5.5, 6, 6.5 or 7 inches long. In some embodiments, anchor 31 can engage one or more apertures 21, 22 and 23. Anchor 31 can be inserted or anchored in surface 6, such as the ground surface, soil or planting medium. Anchor 31 can be inserted or anchored in surface 6 at an angle, such as for example about 25 degrees to about 45 degrees. Thus, support frame 11 is stabilized and/or secured when anchor 31 is inserted into surface 6 and simultaneously engaging lower end 15 of support frame 11. In some embodiments, a plurality, e.g. 2, 3, 4, 5 or 6, of anchors 31 can be used simultaneously to secure support frame 11 to surface 6.

Anchor 31, or related securement mechanisms, can be made from aluminum, plastic, metal, plastic-coated metal, a synthetic composite material, or combinations thereof. In some embodiments, the anchor 31 can be made of a non-corrosive material such as aluminum or plastic. As one of ordinary skill in the art will appreciate, other securement devices or mechanisms can be employed to secure support frame 11 to the ground surface 6.

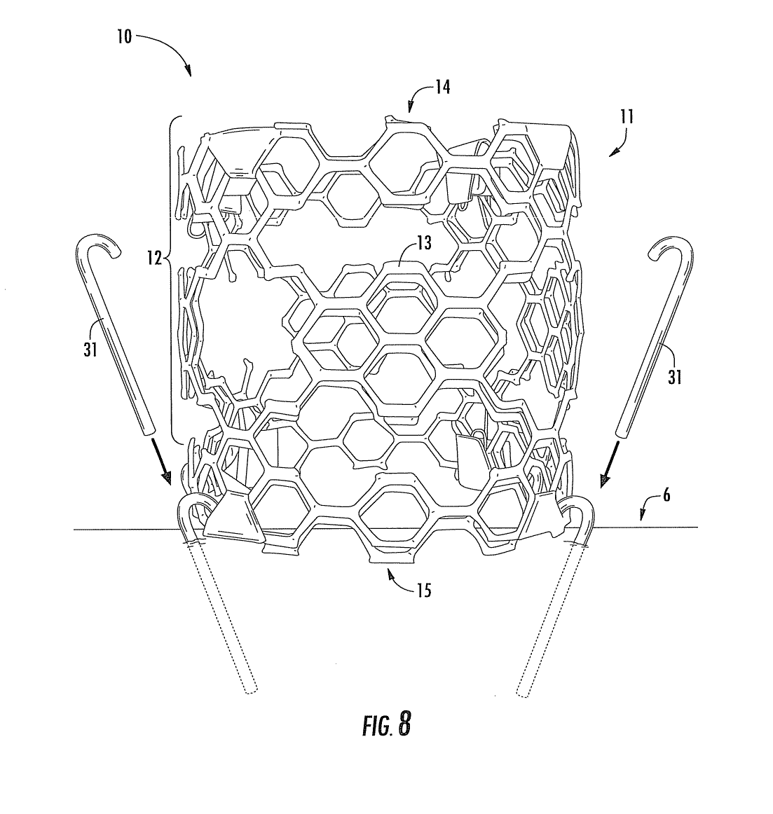

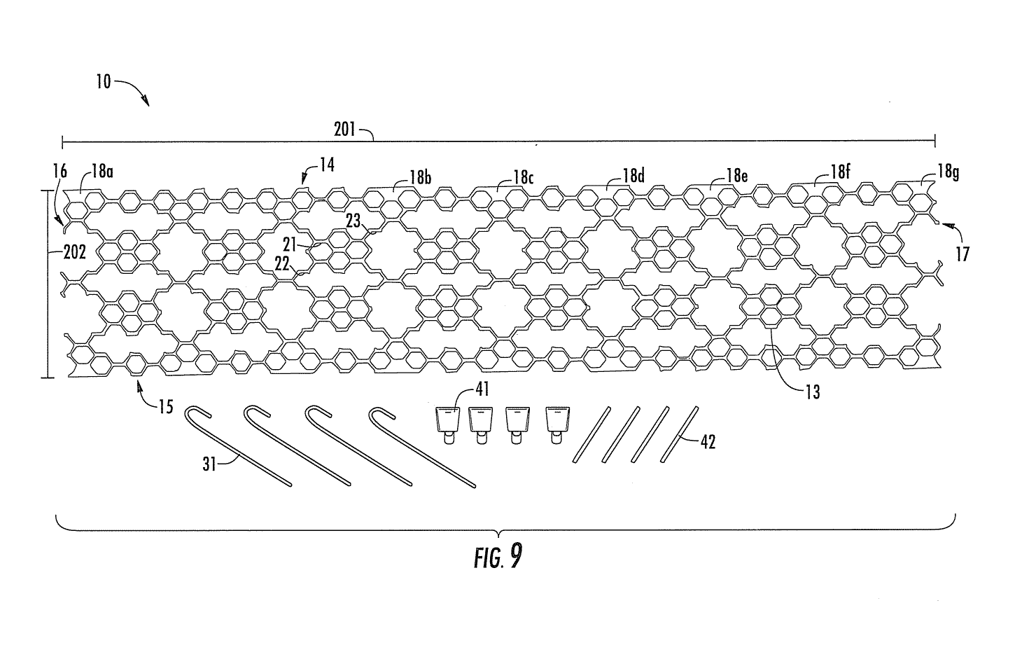

FIG. 9 is a plan view of a second embodiment of a plant support system 10, including components that can be provided in a plant support system kit. Plant support system 10, as illustrated in FIG. 9, can comprise a mesh material 13 (used to form a mesh wall structure of a support frame as discussed below), a securement mechanism, such as for example anchors 31, and fasteners, including for example clips 41 and/or twist ties 42. Mesh material 13 can comprise a substantially planar structure of various widths and lengths and having holes, perforations or apertures throughout. Mesh material 13 can comprise an upper edge 14, a lower edge 15, a first end 16 and a second end 17. Mesh material 13 can comprise tabs 18 distributed along upper edge 14 and/or lower edge 15 as desired. Apertures 21, 22 and 23 in mesh material 13 can comprise various shapes and sizes depending on the desired application of plant support system 10.

Plant support system 10 illustrated in FIG. 9 is similar to that depicted in FIG. 2 other than the size and scale of mesh material 13 used to form support frame 11. Mesh material 13 can have any desirable length 201, or can be cut to any desirable length. In some embodiments, mesh material 13 as depicted in FIG. 9 can have a length 201 ranging from about 20 inches to about 45 inches. In some embodiments, mesh material 13 as depicted in FIG. 9 can have a length 201 of about 20, 21, 22, 23, 24, 25, 26, 27, 28, 29, 30, 31, 32, 33, 34, 35, 36, 37, 38, 39, 40, 41, 42, 43, 44 or 45 inches. In some embodiments, mesh material 13 as depicted in FIG. 2 can have a length 201 of about 34 inches. In some embodiments, mesh material 13 as depicted in FIG. 9 can have a height 209 of about 4 inches to about 11 inches. In some embodiments, mesh material 13 as depicted in FIG. 9 can have a height 202 of about 4, 5, 6, 7, 8, 9, 10 or 11 inches. In some embodiments, mesh material 13 as depicted in FIG. 9 can have a height 202 of about 7 inches.

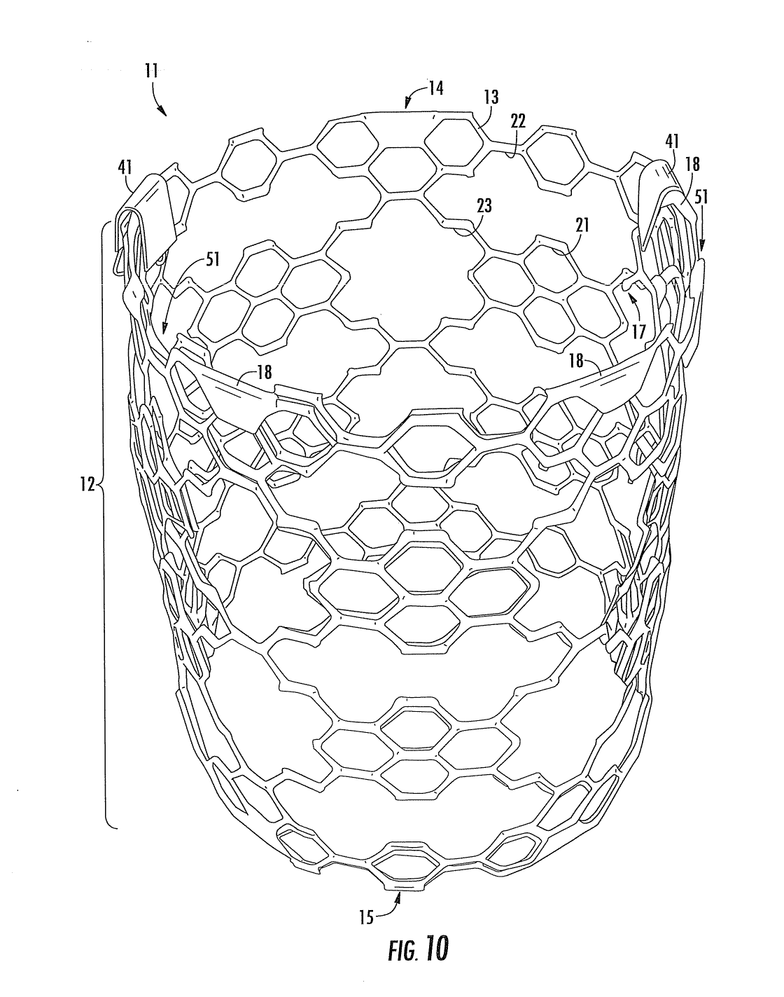

In some embodiments, mesh material 13 as depicted in FIG. 9 can have tab 18a on upper edge 14 and/or lower edge 15 and proximal to first end 16. In some embodiments, mesh material 13 can have an additional one to 10 tabs 18 spaced along upper edge 14 and/or lower edge 15 and starting from second end 17. By way of example and not limitation, FIG. 2 depicts tabs 18b, 18c, 18d, 18e, 18f and 18g. Alignment of tabs 18b, 18c, 18d, 18e, 18f and 18g with 18a, when mesh material 13 is deformed into support frame 11 (see FIG. 10), provide for a support frame 11 with a diameter of 4 inches, 5.5 inches, 7 inches, 8.5 inches, 10 inches & 11.5 inches respectively. That is, tabs 18b (4 inch tab), 18c (5.5 inch tab), 18d (7 inch tab), 18e (8.5 inch tab), 18f (10 inch tab) and 18g (11.5 inch tab), when aligned with tab 18a, provide a guide for a desired diameter of support frame 11.

FIG. 10 is a perspective view of support frame 11 constructed from components of plant support system 10 depicted in FIG. 9. As depicted in FIG. 7, support frame 11 of FIG. 10 can comprise a cylindrical structure formed from mesh material 13 and having a mesh wall structure 12. However, because the height of mesh material 13 used to construct support frame 11 is greater than that used to construct support frame 11 of FIG. 7, the support frame 11 depicted in FIG. 10 is of a greater height. Similar to that depicted in FIG. 7, support frame 11 of FIG. 10 can be provided with fasteners 41 to hold mesh material 13 in the cylindrical shape to provide for support frame 11. Fasteners 41 can be used to secure first and second ends 16 and 17 into place. In some embodiments, fasteners 41 can comprise a clip that can slide over the top of upper edge 14 and/or lower edge 15 of mesh material 13 to hold first and second ends 16 and 17 into place. In some embodiments, fasteners 41 can be secured on both upper edge 14 and lower edge 15 of mesh material 13 to hold first and second ends 16 and 17 into place. In some embodiments four fasteners 41 can be used simultaneously to retain the cylindrical shape of support frame 11. However, as would be appreciated by one of ordinary skill in the art, any number of fasteners 41 can be used as necessary to retain the cylindrical shape of support frame 11.

In an upright position, as depicted in FIG. 10, support frame 11 comprises an upper edge 14 and lower edge 15. In some embodiments, and as depicted in FIG. 10, mesh material 13 deformed into the cylindrical structure support frame 11 forms overlapping regions 51 of mesh material 13. The degree to which overlapping regions 51 exist is determined by the diameter of the cylindrical structure of support frame 11. That is, for a given length of mesh material 13, deformation of mesh material 13 into a smaller diameter cylinder will result in more overlap regions 51 as compared deformation of the same length of mesh material 13 into a larger diameter cylindrical. A user of a support frame 11 and plant support system 10 disclosed herein can choose the appropriate diameter for support frame 11, depending in part on the particular application of the plant support system 10. Moreover, the diameter of support frame 11 can be adjusted as needed by removing fastener(s) 41 and adjusting the deformation of mesh material 13 to achieve the desired diameter.

Support frame 11 can, in some embodiments, have a height of about 4, 5, 6, 7, 8, 9, 10 or 11 inches. As depicted in FIG. 10, support frame 11 can have a height of about inches. Support frame 11 can, in some embodiments, have a diameter of about 4, 5.5, 7, 8.5, 10 or 11.5 inches. Support frame 11 as depicted in FIG. 10 can be suitable for supporting plants expected to grow to about 14 to about 24 inches in height.

As depicted in FIG. 10, wall structure 12 of support frame 11 can comprise hexagonal shaped apertures 21, hexslot apertures 22 and hexstar apertures 23. As one of ordinary skill in the art will appreciate, any size, shape and/or combination of aperture(s) can be used in mesh wall structure 12 of support frame 11 without departing from the scope of the instant disclosure. Some considerations for the size and shape of the aperture(s) employed in a given mesh wall structure 12 of support frame 11 can include the type of plant to be supported by support frame 11, the stage of growth of the plant, the stage of the growing season, the environment and/or soil condition where the plant is to be grown, the presence or absence of pests, etc. In some embodiments, and as depicted in FIG. 10, these apertures (21, 22 and 23) can be aligned in overlapping regions 51 of mesh material 13 so as not to obstruct the openings of each, of apertures 21, 22 and 23. To facilitate the alignment of the apertures 21, 22 and 23, tabs 18 can be provided in some embodiments. Tabs 18 can be placed at or near the top (upper edge 14) of support frame 11 and/or at or near the bottom (lower edge 15) of support frame 11. Tabs 18 can be arranged such that alignment thereof ensures that apertures (such as apertures 21, 22 and 23) in wall structure 12 are also aligned. In some embodiments, a plurality of tabs 18 can be provided along upper edge 14 and/or lower edge 15, as depicted in FIG. 10. In some embodiments, tabs 18 can have a size and shape that provides a secure engagement with the fastener(s) 41 so that fastener(s) 41 securely hold mesh material 13 in place to form support frame 11. In some embodiments, tabs 18 can comprise indicators thereon to identify a size of the support frame 11 being formed when tabs 18 are aligned. The indicators on tabs 18 can have markings thereon so that respective tabs 18 can be matched to form different settings to which a diameter of support frame 11 is adjustable.

FIG. 11 is a plan view of a third embodiment of a plant support system 10, including components that can be provided in a plant support system kit. Plant support system 10, as illustrated in FIG. 11, can comprise a mesh material 13 (used to form a mesh wall structure of a support frame as discussed below) and fasteners, including for example clips 41, twist ties 42 and/or cable ties 43. Mesh material 13 can comprise a substantially planar structure of various widths and lengths and having holes, perforations or apertures throughout. Mesh material 13 can comprise an upper edge 14, a lower edge 15, a first end 16 and a second end 17. Mesh material 13 can comprise tabs 18 distributed along upper edge 14 and/or lower edge 15 as desired. Apertures 21 and 22 in mesh material 13 can comprise various shapes and sizes depending on the desired application of plant support system 10.

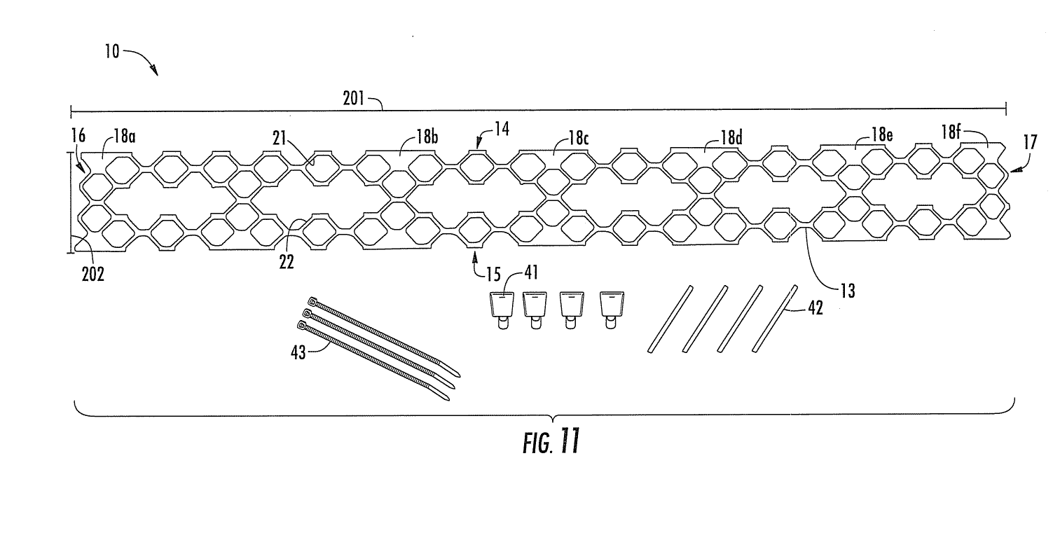

Plant support system 10 illustrated in FIG. 11 is similar to that depicted in FIGS. 2 and 9 other than the size and scale of mesh material 13 used to form support frame 11. Additionally, plant support system 10 illustrated in FIG. 11 differs from that depicted in FIGS. 2 and 9 in that no securement mechanism, e.g. anchor 31, is provided. This is because plant support system 10 illustrated in FIG. 11 is designed to be used in conjunction with stake 61, as illustrate in FIG. 12.

Similar to that depicted in FIGS. 7 and ^{10,} support frame 11 of FIG. 12 can be provided with fasteners 41 to hold mesh material 13 in the cylindrical shape to provide for support frame 11. Fasteners 41 can be used to secure first and second ends 16 and 17 into place. In some embodiments, fasteners 41 can comprise a clip that can slide over the top of upper edge 14 and/or lower edge 15 of mesh material 13 to hold first and second ends 16 and 17 into place. In some embodiments, fasteners 41 can be secured on both upper edge 14 and lower edge 15 of mesh material 13 to hold first and second ends 16 and 17 into place. In some embodiments four fasteners 41 can be used simultaneously to retain the cylindrical shape of support frame 11. However, as would be appreciated by one of ordinary skill in the art, any number of fasteners 41 can be used as necessary to retain the cylindrical shape of support frame 11.

In an upright position, as depicted in FIG. 12, support frame 11 can comprise an upper edge 14 and lower edge 15. In some embodiments, and as depicted in FIG. 12, mesh material 13 deformed into the cylindrical structure support frame 11 forms overlapping regions 51 of mesh material 13. The degree to which overlapping regions 51 exist is determined by the diameter of the cylindrical structure of support frame 11. That is, for a given length of mesh material 13, deformation of mesh material 13 into a smaller diameter cylinder will result in more overlap regions 51 as compared deformation of the same length of mesh material 13 into a larger diameter cylindrical. A user of a support frame 11 and plant support system 10 disclosed herein can choose the appropriate diameter for support frame 11, depending in part on the particular application of the plant support system 10. Moreover, the diameter of support frame 11 can be adjusted as needed by removing fastener(s) 41 and adjusting the deformation of mesh material 13 to achieve the desired diameter.

Support frame 11 can, in some embodiments, have a height of about 2, 3, 4, 5, 6, 7, 8 or 9 inches. As depicted in FIG. 12, support frame 11 can for example have a height of about 3 inches. Support frame 11 can, in some embodiments, have a diameter of about 2.5, 4, 5.5, 7 or 8.5 inches. Support frame 11, as depicted in FIG. 12, and used in conjunction with a stake 61 (see below) can be suitable for supporting plants expected to grow to about 2 feet to about 5 feet in height.

As depicted in FIG. 12, wall structure 12 of support frame 11 can comprise hexagonal shaped apertures 21 and hexslot apertures 22. Though not depicted in FIG. 12, hexstar apertures 23 apertures (see FIGS. 7 and 10) could also be included. As one of ordinary skill in the art will appreciate, any size, shape and/or combination of aperture(s) can be used in mesh wall structure 12 of support frame 11 without departing from the scope of the instant disclosure. Some considerations for the size and shape of the aperture(s) employed in a given mesh wall structure 12 of support frame 11 can include the type of plant to be supported by support frame 11, the stage of growth of the plant, the stage of the growing season, the environment and/or soil condition where the plant is to be grown, the presence or absence of pests, etc.

In some embodiments, and as depicted in FIG. 12, these apertures (21 and 22) can be aligned in overlapping regions 51 of mesh material 13 so as not to obstruct the openings of each of apertures 21 and 22. To facilitate the alignment of the apertures 21, and 22, tabs 18 can be provided in some embodiments. Tabs 18 can be placed at or near the top (upper edge 14) of support frame 11 and/or at or near the bottom (lower edge 15) of support frame 11. Tabs 18 can be arranged such that alignment thereof ensures that apertures (such as apertures 21 and 22) in wall structure 12 are also aligned. In some embodiments, a plurality of tabs 18 can be provided along upper edge 14 and/or lower edge 15, as depicted in FIG. 12. In some embodiments, tabs 18 can have a size and shape that provides a secure engagement with the fastener(s) 41 so that fastener(s) 41 securely hold mesh material 13 in place to form support frame 11. In some embodiments, tabs 18 can comprise indicators thereon to identify a size of the support frame 11 being formed when tabs 18 are aligned. The indicators on tabs 18 can have markings thereon so that respective tabs 18 can be matched to form different settings to which a diameter of support frame 11 is adjustable.

In some embodiments, plant support system 10 illustrated in FIG. 11 is designed to be used in conjunction with stake 61, as illustrate in FIG. 12. Unlike plant support systems 10 in FIGS. 7 and 10, plant support systems 10 in FIG. 12 is affixed to stake 51 to provide support for a plant. Stake 61 can comprise any stake, pole, rod, post, trellis or the like commonly used in gardening and horticulture. Stake 61 can be about 1 foot, 2 feet, 3 feet, 4 feet, 5 feet or 6 feet in length. Stake 61 can be made of wood, plastic, aluminum, metal or synthetic composite material. In some embodiments, a kit of a plant support system 10 as depicted in FIG. 11 does not include stake 61, while in other embodiments stake 61 is included.

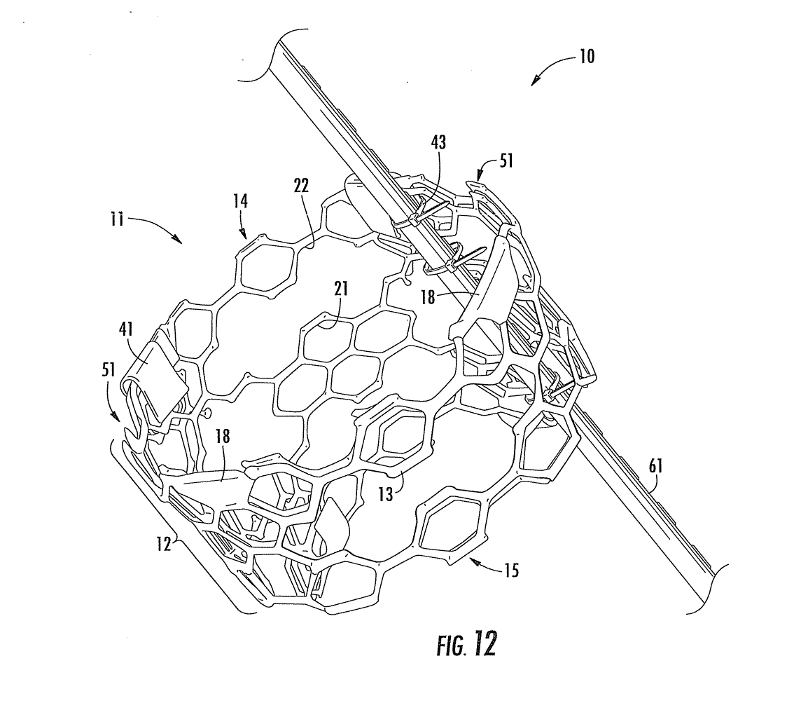

Support frame 11 can be secured to stake 61 using any suitable means. In some embodiments, cable ties 43 can be used to secure support frame 11 to stake 61, as depicted in FIG. 12. In some embodiments, wire, twist ties, string, and the like can be used to secure support frame 11 to stake 61. Support frame 11 can be secured to stake 61 at a height suitable to adequately support plant 5 to which support frame 11 is to provide support as depicted in FIG. 13.

Mesh material 13 can have any desirable length 201, or can be cut to any desirable length. In some embodiments, mesh material 13 as depicted in FIG. 11 can have a length 201 ranging from about 15 inches to about 40 inches. In some embodiments, mesh material 13 as depicted in FIG. 11 can have a length 201 of about 15, 16, 17, 18, 19, 20, 21, 22, 23, 24, 25, 26, 27, 28, 29, 30, 31, 32, 33, 34, 35, 36, 37, 38, 39 or 40 inches. In some embodiments, mesh material 13 as depicted in FIG. 11 can have a length 201 of about 29 inches. In some embodiments, mesh material 13 as depicted in FIG. 11 can have a height 202 of about 3 inches to about 9 inches. In some embodiments, mesh material 13 as depicted in FIG. 11 can have a height 202 of about 3, 4, 5, 6, 7, 8 or 9 inches. In some embodiments, mesh material 13 as depicted in FIG. 11 can have a height 202 of about 3 inches.

In some embodiments, mesh material 13 as depicted in FIG. 11 can have tab 18a on upper edge 14 and/or lower edge 15 and proximal to first end 16. In some embodiments, mesh material 13 can have an additional one to nine tabs 18 spaced along upper edge 14 and/or lower edge 15 and starting from second end 17. By way of example and not limitation, FIG. 11 depicts tabs 18b, 18c, 18d, 18e and 18f. Alignment of tabs 18b, 18c, 18d, 18e and 18f with 18a, when mesh material 13 is deformed into support frame 11 (see FIG. 12), provide for a support frame 11 with a diameter of 4 inches, 5 inches, 6 inches, 7 inches and 8 inches, respectively. That is, tabs 18b (2.5 inch tab), 18c (4 inch tab), 18d (5.5 inch tab), 18e (7 inch tab), and 18f (8.5 inch tab), when aligned with tab 18a, provide a guide for a desired diameter of support frame 11.

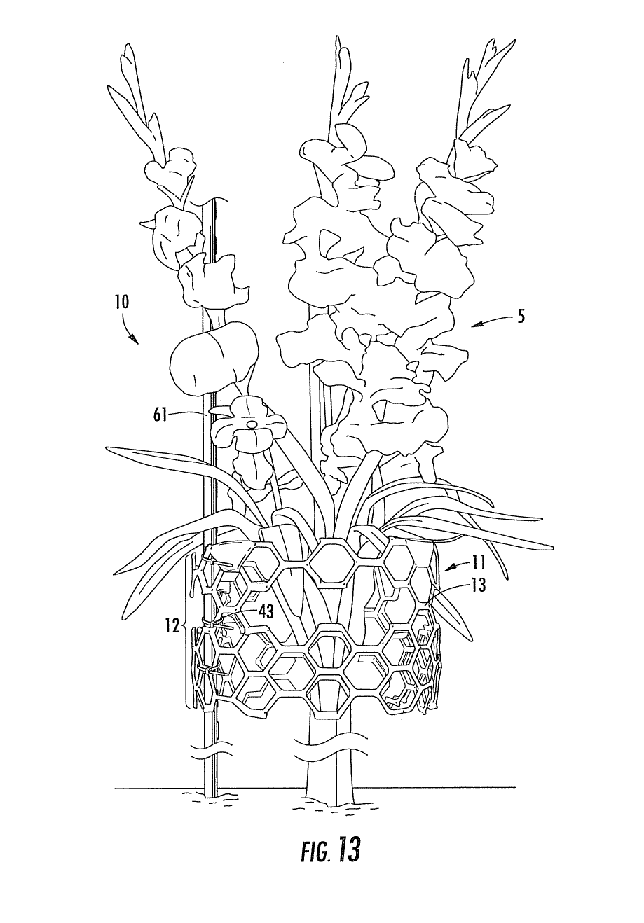

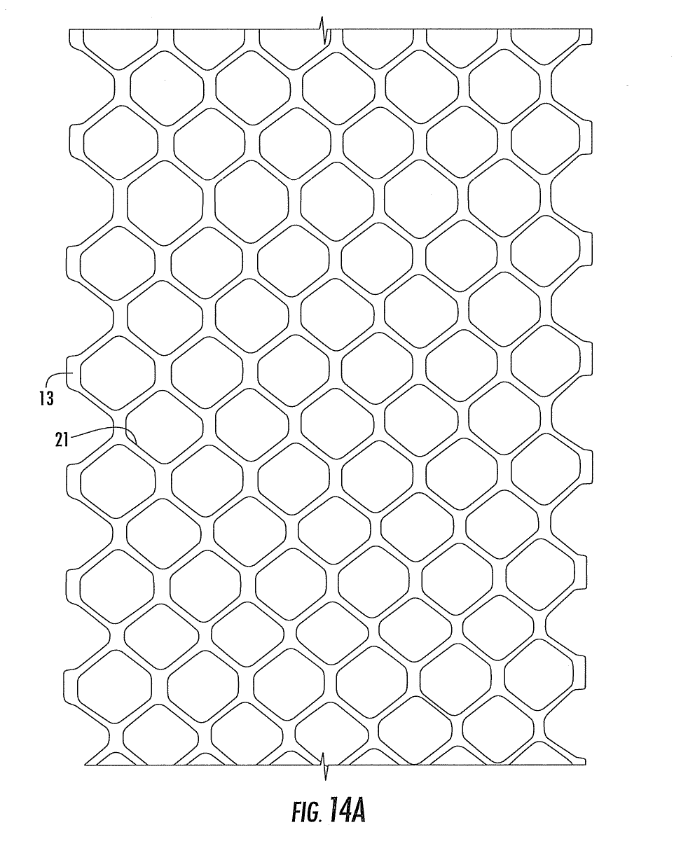

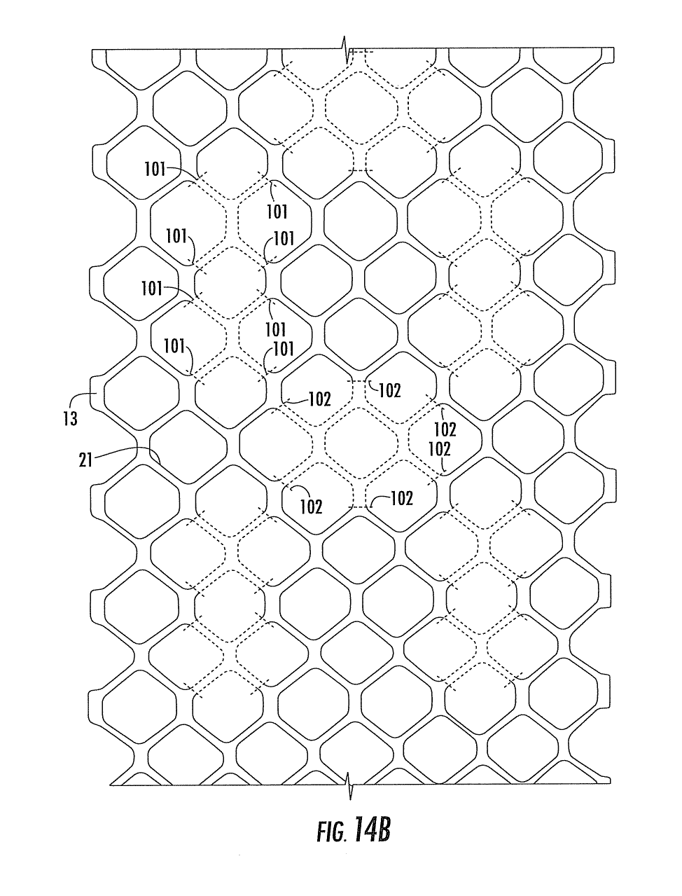

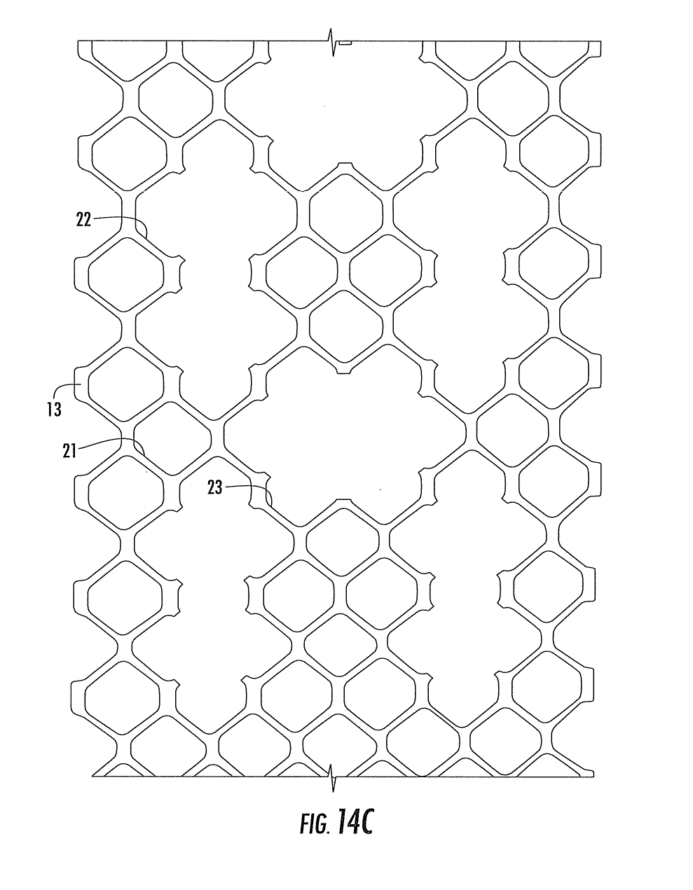

FIGS. 14A-14C are plan views of a mesh structure in a series of steps illustrating the creation of apertures in the mesh structure to create a wall structure of a plant support system. In some embodiments mesh material 13 can start as a contiguous sheet or roll or mess material with repeating apertures 21. In some embodiments, a section, piece or portion of such a mesh material can be cut to size and used as depicted in FIG. 14C to form a support frame 11 as depicted in any of FIGS. 7, 10 and 12. However, in some embodiments, additional apertures of various sizes and shapes might be desirable. As such, steps can be taken to create such additional apertures as depicted in FIGS. 14B and 14C. To do so a user can ascertain the size and shape of the aperture desired. By way of example and not limitation, hexslot apertures 22 and hexstar apertures 23 are created in mesh material 13 in FIGS. 14B and 14C. However, as would be appreciated by one of ordinary skill in the art, any size and/or shape of aperture can be created as determined by a user for a given use. To create hexslot apertures 22 mesh material 13 is cut at cut lines 101, as illustrated in FIG. 14B. In some embodiments, lines or marks can be made on the mesh material 13 to serve as a guide for making cuts 101. To create hexstar apertures 23 mesh material 13 is cut at cut lines 102. In some embodiments, lines or marks can be made on the mesh material 13 to serve as a guide for making cuts 102. Cuts can be made using any suitable cutting tool, such as sheers or scissors, of by using an industrial machine. FIG. 14C shows mesh material 13 with apertures 21, 22 and 23, wherein apertures 22 and 23 have been cut from the existing repeating pattern of apertures 21. The pattern of apertures 21, 22 and 23 depicted in FIG. 14C, or any other desired pattern or combination of apertures, can be continued for any length of mesh material 13 as needed.

In some embodiments, mesh material 13 can be constructed with apertures as needed thereby precluding the need to cut additional and/or larger apertures. For example, mesh material 13 can be cast, molded, injection-molded or formed as depicted in FIG. 14C, i.e. with apertures 21, 22 and 23. A process that provides mesh material 13 with all desired apertures precludes the need to create additional apertures and allows for scaled-up production of plant support systems 10.

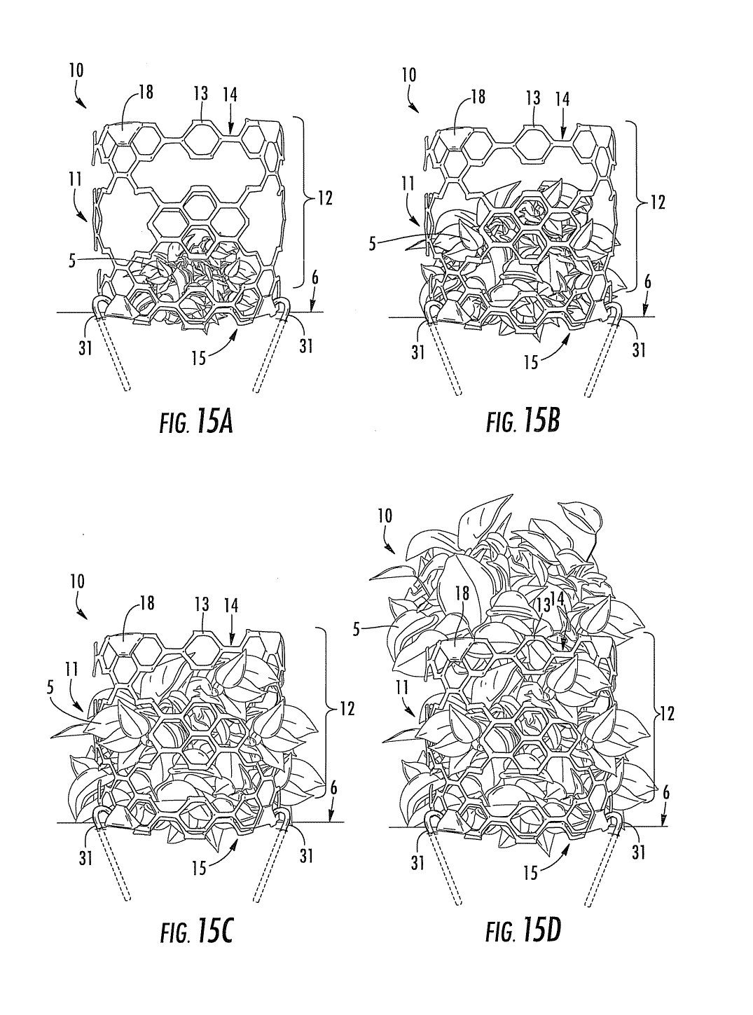

FIGS. 15A-15D are side views of a plant support system 10 in use to provide structural support to a plant through various stages of growth of the plant. FIG. 15A depicts plant support system 10, including support frame 11 and anchors 31, used to support a young plant or newly planted plant. In FIG. 15A support frame 11 is placed around the periphery of plant 5 and anchors 31 inserted into ground surface 6 to secure plant support system 10 around plant 5 to thereby support plant 5 as the plant grows. Of note, in some embodiments anchors 31 can be optional if not needed to secure support frame 11 into place. During the early stage of growth, and particularly shortly after planting (FIG. 15A), plant support system 10 can create a barrier to pests, e.g. rabbits and squirrels, thereby providing protection to the young plant. As the plant matures plant support system 10 continues to provide protection to the plant while also providing structural support.

FIGS. 15B and 15C depict plant 5 during intermediate stages of growth and development with plant support system 10 providing support and protection for plant 5. As can be seen in FIGS. 15B and 15C, as plant 5 grows portions of the plant, e.g. leaves and stems, begin to protrude through apertures 21, 22 and 23. As plant 5 grows through apertures 21, 22 and 23 of support frame 11 the plant is stabilized. Such support and stabilization promotes growth and prevents damage caused by the plant's own weight. For example, as plant 5 grows, vertical and lateral growth, and particularly top-heavy weight, cause strain on the structural elements of plant 5 which can lead to snapping or splitting of the stalk. Such damage can retard growth, diminish ornamental qualities, and invite insect predation and disease.

At full maturity, as depicted in FIG. 15D, plant 5 can extend vertically above upper edge 14 of support frame 11 and horizontally beyond wall structure 12. At full maturity portions of plant 5, e.g. leaves and stems, through apertures 21, 22 and 23, thereby providing vertical and lateral support and stability of plant 5. Additionally, notches along upper edge 14 provide stability to an upper portion of plant 5 by reducing the lateral movement of plant 5. As depicted in FIG. 15D, the entirety of plant 5, or a substantial portion of plant 5, can be fully supported by plant support system 10. By providing full support to all or most of plant 5 the plant is less susceptible to damage from its own weight or from rain and wind. The full support provided by plant support system 10 also can allow plant 5 to grow taller and with an upright posture. Such supported growth can increase the aesthetic appeal, value and productivity of plant 5. At full maturity plant 5 can fully engulf plant support system 10 such that plant support system 10 is no longer visible. Thus, the aesthetic appeal and health of plant 5 can be maximized while plant support system 10 does not detract from the visual appearance of plant 5. In some embodiments, plant support system 10, or components thereof, e.g. support frame 11, can be green, brown or other natural color such that it blends in with plant 5.

Plant support system 10 can be used in a method of supporting a plant 5. Such a method can comprise selecting a mesh material 13 (FIGS. 2, 9 and 11), optionally creating additional apertures as needed, e.g. apertures 21, 22 and 23 (FIGS. 13A, B and C), deforming mesh material 13 to form support frame 11 (FIGS. 4-7, 10 and 12), and placing support frame 11 around the periphery of a plant 5 to be supported (FIGS. 14A-14D). Anchors 31 can be used to secure support frame 11 to ground surface 6 as needed. Deformation of mesh material 13 to form support frame 11 can be done to achieve a diameter of support frame 11 as needed depending on the current or expected size of plant 5. In some embodiments, the size/diameter of support frame 11 can be adjusted as necessary to properly fit plant 5 initially or at a later stage of growth. In some embodiments, support frame 11 can be affixed to stake 61 and place around a section of plant 5 (FIG. 12).

In some embodiments, a plant support system 10 kit is provided. In some embodiments, components of such a kit are depicted in FIGS. 2, 9 and 11. For example, in some embodiments, a plant support system 10 kit can comprise a mesh material 13 (used to form a mesh wall structure of a support frame as discussed below), a securement mechanism, such as for example anchors 31, and fasteners, including for example clips 41 and/or twist ties 42. Mesh material 13 can comprise a substantially planar structure of various widths and lengths and having holes, perforations or apertures throughout. In some embodiments a plant support system 10 kit can further comprise instructions for assembling a plant support system 10. In some embodiments, instructions can be provided for creating additional apertures in a mesh material 13, such as for example apertures 22 and 23. In some embodiments, instructions for creating additional apertures in mesh material 13 can comprise a template for such apertures. In some embodiments, a kit can further comprise a stake 61 as depicted in FIG. 12. In some embodiments, a kit can comprise sufficient components to assemble a plurality of plant support systems 10, either of the same size or of multiple sizes.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A plant support system comprising:
a support frame to support a plant, wherein the support frame comprises a mesh wall structure comprising a mesh material, wherein the support frame is positionable at a perimeter of at least a portion of a plant;
a plurality of apertures positioned throughout the support frame to facilitate growth therethrough by the plant; and
at least one securement mechanism to secure the support frame to a surface from which a plant is growing.

2. The plant support system according to claim 1, further comprising one or more fasteners that are securable to the mesh wall structure to hold the mesh wall structure in a deformed shape of the support frame.

3. The plant support system according to claim 2, wherein the one or more fasteners comprise one or more clips.

4. The plant support system according to claim 2, wherein the one or more fasteners comprise one or more ties that are securable on overlapping portions of the mesh wall structure.

5. The plant support system according to claim 1, wherein the mesh wall structure comprises a skeletal framework of interconnected links that define the plurality of apertures, wherein the plurality of apertures comprise apertures of a plurality of different shapes and sizes.

6. The plant support system according to claim 5, wherein the apertures of the plurality of different shapes and sizes defined by the mesh wall structure comprise at least one of hexagonal shape, rectangular shape, circular shape, oval shape, elliptical shape, triangular shape, star shape, slot shape, hexagonal slot shape, hexagonal star shape, hexslot, hexstar, curved slot shape, or curved star shape.

7. The plant support system according to claim 1, wherein the support frame comprises a cylindrical ring structure.

8. The plant support system according to claim 1, wherein the support frame is adjustable to different diameters.

9. The plant support system according to claim 1, wherein the apertures in the mesh wall structure are alignable in overlapping regions of the mesh wall structure when the mesh wall structure is deformed into the support frame.

10. The plant support system according to claim 9, wherein the mesh wall structure comprises tabs that are alignable when the mesh wall structure is deformed into the support frame to indicate that the apertures are properly aligned.

11. The plant support system according to claim 10, wherein the tabs comprise indicators to identify a size of the support frame being formed when the tabs are aligned.

12. The plant support system according to claim 1, wherein the mesh material comprises a plastic material.

13. The plant support system according to claim 1, wherein the at least one securement mechanism comprises one or more ground anchors.

14. The plant support system according to claim 1, wherein the apertures in the mesh wall structure permit growth of the plant therethrough so that the support frame is at least partially concealable by the plant at a later stage of growth while the support frame provides infrastructural support to the plant.

15. A method for supporting a plant, the method comprising:
providing a mesh material, wherein the mesh material has a first and second end;
providing a fastener;
deforming the mesh material into a cylindrical shape and fastening the first and second ends using the fastener to thereby form a support frame; and
positioning the support frame around the periphery of a plant to be supported.

16. The method of claim 15, further comprising creating a plurality of apertures in the mesh material.

17. The method of claim 15, wherein the fasteners comprise clips or ties.

18. The method of claim 15, wherein the mesh material comprises a plastic mesh material.

19. The method of claim 15, further comprising providing a securing mechanism and securing the support frame to a surface from which the plant is growing.

20. A plant support system kit, the kit comprising:
a mesh material suitable for forming a cylindrical-shaped support frame;
fasteners to secure the mesh material in a cylindrical-shaped support frame; and
securing mechanisms to secure the support frame to a surface form which a plant is growing.

21. The kit of claim 20, further comprising instructions for making and using the plant support system, wherein the instructions comprise instructions for creating apertures in the mesh material.

22. The kit of claim 20, wherein the mesh material is suitable for forming a support frame of various sizes for use with a variety of plants.
